(19) United States
(12) Patent Application Publication
(10) Pub. No.: US 2009/0304511 A1
(43) Pub. Date: Dec. 10, 2009

(54) AERODYNAMIC SHROUD HAVING TEXTURED SURFACE

(76) Inventor: William W. Brannon, III, Johnson City, TN (US)

Correspondence Address: FOX ROTHSCHILD LLP, 2000 MARKET STREET, 10th Floor, PHILADELPHIA, PA, 19103, US

(21) Appl. No.: 12/088,770

(22) PCT Filed: Sep. 27, 2006
(86) PCT No.: PCT/US06/37495

§ 371 Date: Aug. 13, 2009

Related U.S. Application Data
(60) Provisional application No. 60/722,350, filed on Sep. 30, 2005.

(51) Int. Cl. B64C 27/20

(52) U.S. Cl. 416/179

(57) ABSTRACT

An aerodynamic shroud positionable surrounding a hub to which blades are attached is disclosed. The shroud has a textured outer surface that is configured so as to create a turbulent boundary layer for fluid flowing over the surface. The turbulent boundary layer delays flow separation from the shroud and reduces drag. The shroud may be formed from a domed shell mounted on the hub and have skirts that surround the hub. The textured surface is provided by dimples in the surface or projections from the surface. The shroud is intended to reduce main and tail rotor hub drag on helicopters but is also useful on marine propellers, aircraft propellers and jet engine fans.

### FIELD OF THE INVENTION

This invention relates to aerodynamically improved shrouds for reducing drag in aircraft and watercraft.

### BACKGROUND OF THE INVENTION

Helicopters are acknowledged as having poor aerodynamic efficiency as compared with airplanes. Some of the worst aerodynamic helicopter designs experience as much as 20 times the drag of an airplane of comparable gross weight. Even the aerodynamically “cleanest” helicopters exhibit four times more drag than comparable aircraft. It would be advantageous to improve the aerodynamic efficiency for those helicopters whose mission dictates that speed, range and economical performance are important.

Analysis of the aerodynamic characteristics of helicopters indicates that the main rotor hub is the leading cause of drag and accounts for as much as 30% of the total drag of the aircraft. Although much smaller, the tail rotor hub accounts for about 8% of the total aircraft drag, and is in fifth place as a drag producer behind landing gear, the fuselage and nacelles. It is clear from this data that reducing the drag characteristics of the main and tail rotor hubs has the potential to significantly improve the aerodynamic efficiency of helicopters, and thereby improve their performance with respect to speed, range and economy of operation.

### SUMMARY OF THE INVENTION

The invention concerns a shroud positionable on a rotatable hub on which are mounted a plurality of fluid moving blades. The shroud has a textured outer surface configured so as to create a turbulent boundary layer for a fluid passing over the shroud. In one embodiment, the textured outer surface comprises a plurality of dimples in the outer surface. in this embodiment, the dimples may have a round shape. In another embodiment, the textured outer surface comprises a plurality of projections extending from the outer surface.

The shroud may comprise a shell having a domed shape. A skirt may be attached to the shell. The skirt is positionable surrounding the hub. The skirt may be formed of a plurality of panels that attach to one another and the shell.

The invention encompasses various applications such as a shroud for a helicopter rotor assembly. The helicopter rotor assembly according to the invention comprises a rotatable hub to which are attached a plurality of rotor blades. A shroud is mounted on the hub. The shroud comprises a shell having a textured outer surface. The textured outer surface is configured so as to create a turbulent boundary layer for air passing over the shell to reduce drag caused by the rotor assembly and improve helicopter performance.

The shroud according to the invention may also be used on a marine propeller. The marine propeller comprises a hub to which are attached a plurality of propeller blades. A shroud surrounds the hub and has a textured outer surface. The textured outer surface is configured so as to create a turbulent boundary layer for water passing over the shroud.

The invention also includes an aircraft propeller assembly comprising a hub to which are attached a plurality of propeller blades. A shroud surrounds the hub and has a textured outer surface. The textured outer surface is configured so as to create a turbulent boundary layer for air passing over the shroud.

The invention may also be applied to a fan assembly for a turbofan engine. The fan assembly according to the invention comprises a hub to which are attached a plurality of fan blades. A shroud is mounted on the hub and has a textured outer surface. The textured outer surface is configured so as to create a turbulent boundary layer for air passing over the shroud.

### BRIEF DESCRIPTION OF THE DRAWINGS

FIG. 1 is a side view of a helicopter having main rotor and tail rotor assemblies according to the invention;

FIG. 2 is an exploded perspective view on an enlarged scale of the helicopter rotor assembly shown in FIG. 1;

FIG. 3 is a perspective view on an enlarged scale of the tail rotor assembly shown in FIG. 1;

FIG. 4 is a partial sectional view of a shroud embodiment according to the invention;

FIG. 5 is a partial sectional view of another shroud embodiment according to the invention;

FIG. 6 is a top view of a helicopter having a shrouded main rotor assembly according to the prior art and illustrating air flow around the rotor assembly;

FIG. 7 is a top view of a helicopter having a shrouded main rotor assembly according to the invention and illustrating air flow around the rotor assembly;

FIG. 8 is a side view of a watercraft having a marine propeller according to the invention;

FIG. 9 is a detailed view on an enlarged scale of the marine propeller shown in FIG. 8;

FIG. 10 is a perspective view of an aircraft having an aircraft propeller assembly according to the invention;

FIG. 11 is a perspective view of an airliner having a turbofan engine with a turbofan assembly according to the invention; and

FIG. 12 is a detailed view of an enlarged scale of the turbofan assembly shown in FIG. 11.

### DETAILED DESCRIPTION OF THE EMBODIMENTS

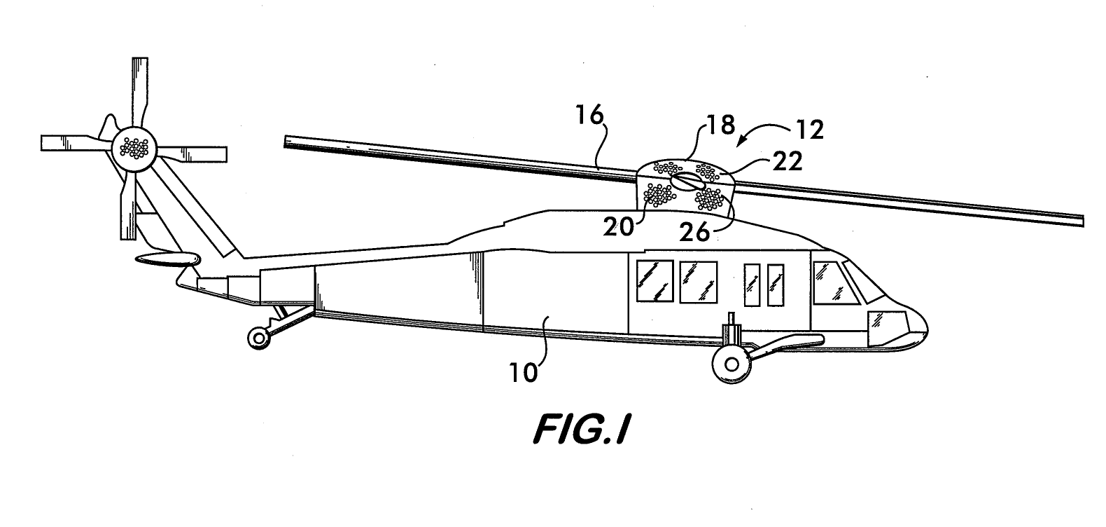

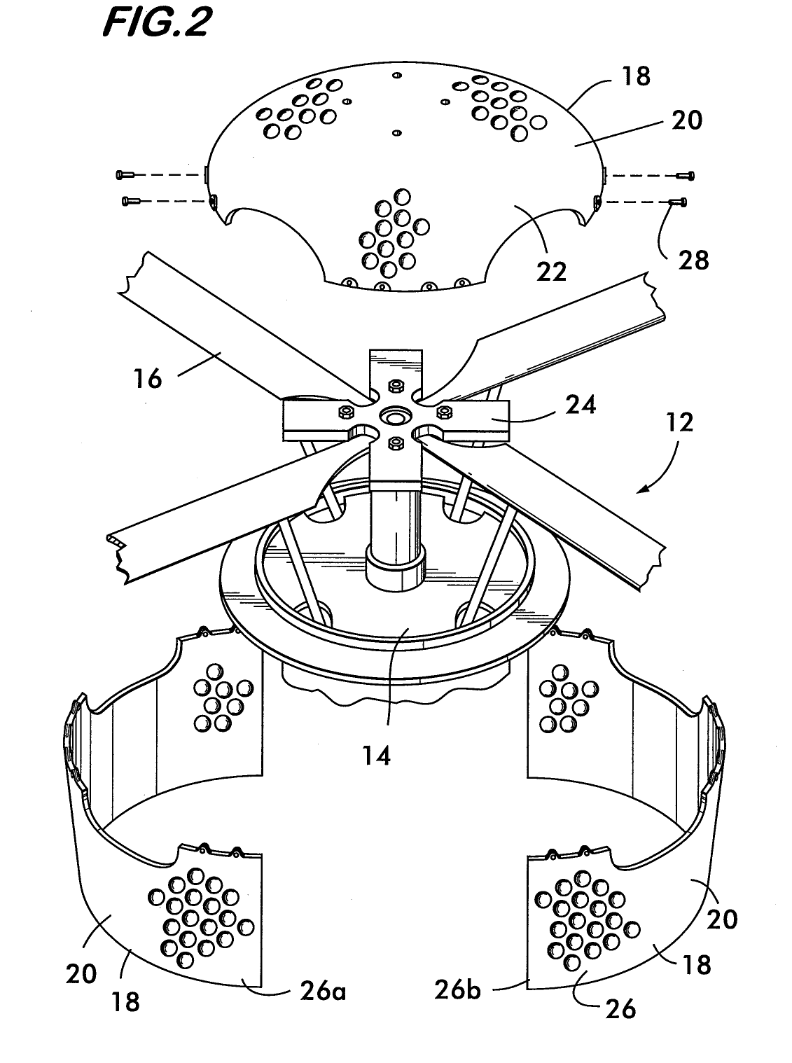

FIG. 1 shows a helicopter 10 having a main rotor hub assembly 12 according to the invention. The main rotor hub assembly (see also FIG. 2) includes a rotatable hub 14 to which a plurality of blades 16 are attached. A shroud 18 having a textured outer surface 20 surrounds the hub. The textured outer surface is configured so as to create a turbulent boundary layer for air passing over the shroud as explained in detail below.

A particular embodiment of the shroud 18 is illustrated in FIG. 2. Shroud 18 comprises a shell 22 having a domed shape. The shell is mounted on the top of the hub and may, for example, be bolted to a component of the rotor structure 24. The shroud 18 may also include a skirt 26. Skirt 26 surrounds the hub and may be attached to the shell 22 by fasteners 28. Preferably, the skirt is formed of a plurality of separate panels such as 26a and 26b which can be easily removed to facilitate repair and maintenance of the main rotor hub 14. Similarly, the shell 22 is preferably removably attached to the hub 14.

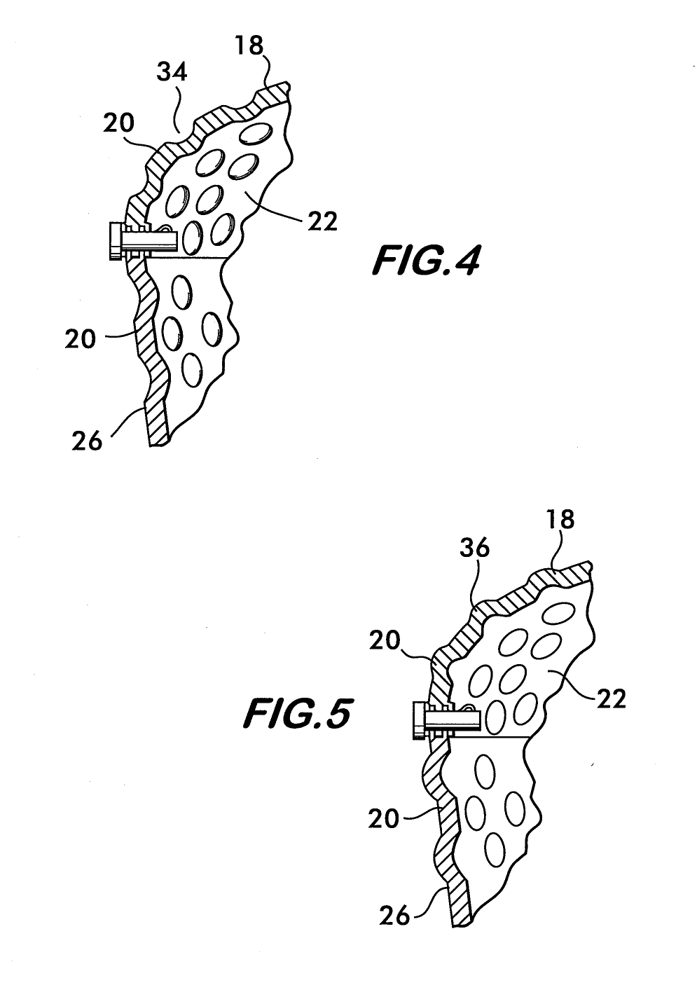

The shell 22 and the skirt 26 have outer surfaces 20 that are textured. In the embodiment shown in FIGS. 2 and 4, the texturing comprises a plurality of dimples 34 distributed over the outer surfaces 20. The dimples in this example are round, but other shapes, such as ellipses and polygons, are also feasible. In an alternate embodiment, shown in FIG. 5, the texturing comprises a plurality of projections 36 extending from the outer surfaces 30 and 32. In this example, the projections are round and relatively small, but other shapes and heights are also feasible as dictated by aerodynamic considerations described below.

Components of the shroud such as the shell and skirt may be constructed of lightweight, high-strength materials such as aluminum, thermoplastics and fiber reinforced composite materials to cite but a few examples.

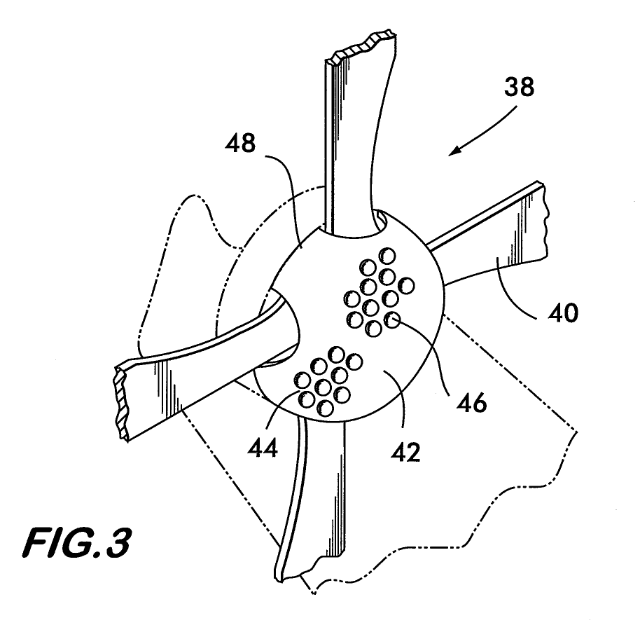

FIG. 3 shows a tail rotor hub assembly 38 according to the invention. Tail rotor blades 40 are attached to the hub which is surrounded by a shroud 42 having a textured outer surface 44. As in the previous example, the texture of the surface is formed by round dimples 46. Other shapes, as well as projections are also feasible as described for the main rotor hub shroud. In this example, the shroud comprises a dome-shaped shell 48, there being no need for separate skirt panels due to the smaller size of the tail rotor.

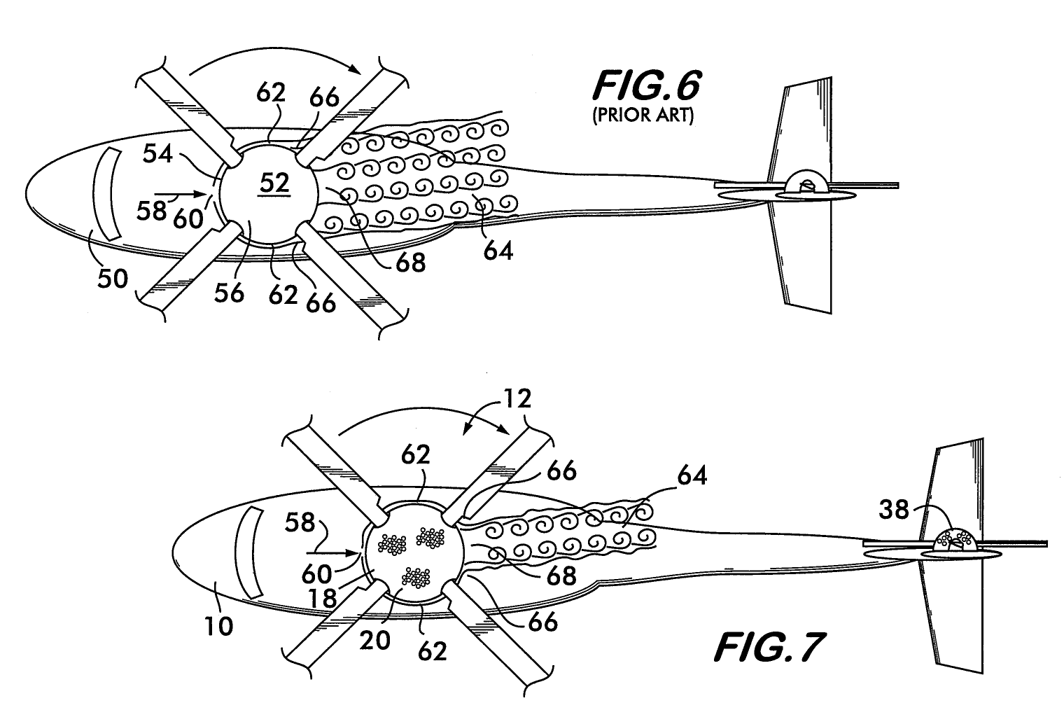

It has been recognized that the main hub of a helicopter, with its various structural components, is a source of significant drag. Attempts have been made to reduce this drag by providing aerodynamically “clean” shrouds or fairings covering the hub's components. While such structures have provided a reduction in drag over unshrouded hubs, they still remain a significant source of drag that degrades the helicopter performance. The aerodynamic advantage in drag reduction for a helicopter having a rotor assembly according to the invention over helicopters having shrouds according to the prior art is explained below with reference to FIGS. 6 and 7.

FIG. 6 shows a helicopter 50 having a shroud 52 according to the prior art mounted on and surrounding the main rotor hub 54. Shroud 52 differs from the shroud 18 according to the invention in that its outer surface 56 is relatively smooth and lacks the surface texturing of the shroud 18 according to the invention. As the helicopter flies in the forward direction, air 58 impinges on the front surface of the shroud and forms a stagnation point 60 of high pressure. The air moves around the shroud 52 in a laminar flow regime where it accelerates and forms low pressure regions 62 along either side of the shroud. As the air continues around to the back of the shroud, it encounters an adverse pressure gradient, i.e., the flow travels in a direction of increasing pressure along the surface of the shroud. The laminar flow does not have sufficient energy or momentum to overcome this pressure gradient and the flow separates from the shroud surface and forms a broad turbulent wake 64 behind the shroud. The separation points 66 form on the back side of the shroud near the middle of the hub. A zone of low pressure 68 forms on the back side of the shroud between the separation points. The larger this low pressure zone is, as indicated by the width of the turbulent wake, the greater the drag on the shroud.

In contrast, FIG. 7 shows the helicopter 10 having the main rotor hub assembly 12 with a shroud 18 according to the invention. Again, as the helicopter 10 flies in the forward direction, a stagnation point 60 of high pressure forms on the front surface of the shroud 18. The air moves around the shroud to regions of lower pressure 62 on opposite sides of the shroud, but the textured outer surface 20 of the shroud disrupts the laminar flow and a turbulent boundary layer is created adjacent to the surface. The turbulent boundary layer has more momentum and energy than the laminar boundary layer. As a result, the air flow around the shroud travels further against the adverse pressure gradient on the back of the shroud before separating from the shroud. Separation occurs at points 66 significantly further around the back of the shroud, resulting in a much smaller zone of low pressure 68, a much narrower turbulent wake 64, and significantly lower drag on the rotor hub assembly. A similar analysis may be performed for the tail rotor hub assembly 38, resulting in lower drag for that component as well.

Lower drag will increase the performance of the helicopter by allowing higher speed for a given power setting as well as greater range and greater fuel economy.

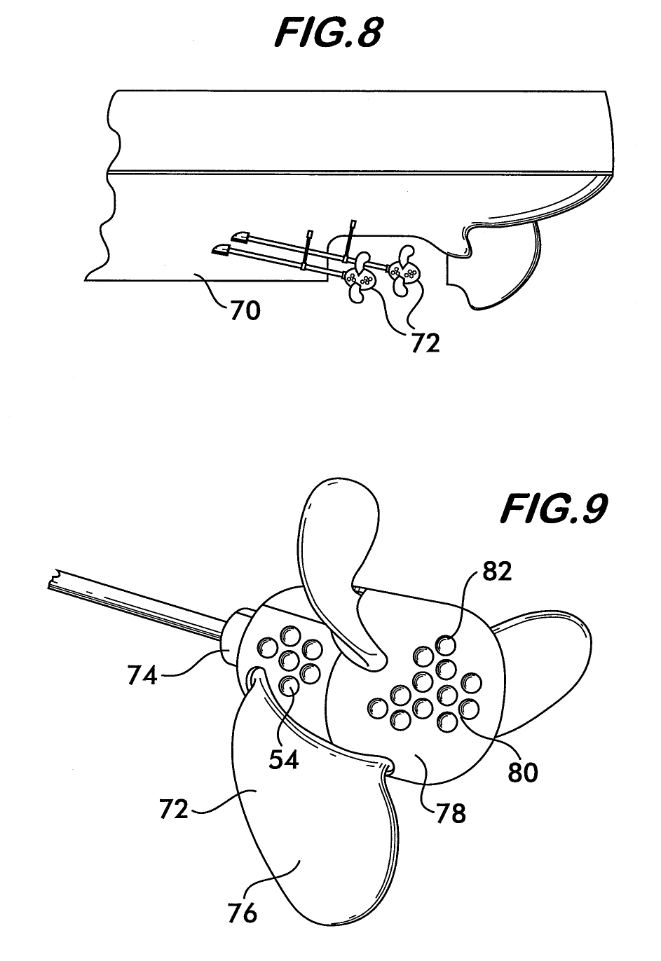

The shroud according to the invention is not limited to use with helicopters, but may also be used on watercraft such as ships, submarines and boats. FIG. 8 shows an exemplary watercraft 70 having a marine propeller 72 according to the invention. The propeller is shown in detail in FIG. 9 and comprises a hub 74 to which blades 76 are attached. A shroud 78 having a textured outer surface 80 surrounds the hub. The texture may be created by dimples 82 or projections 84 distributed over the surface. Cavitation and a resulting power loss are common problems associated with marine propellers. It is believed that providing a marine propeller with a hub surrounded by a shroud having a textured surface will result in lower vibratory loads and lower drag, enabling the vessel to travel faster and farther on a given power setting.

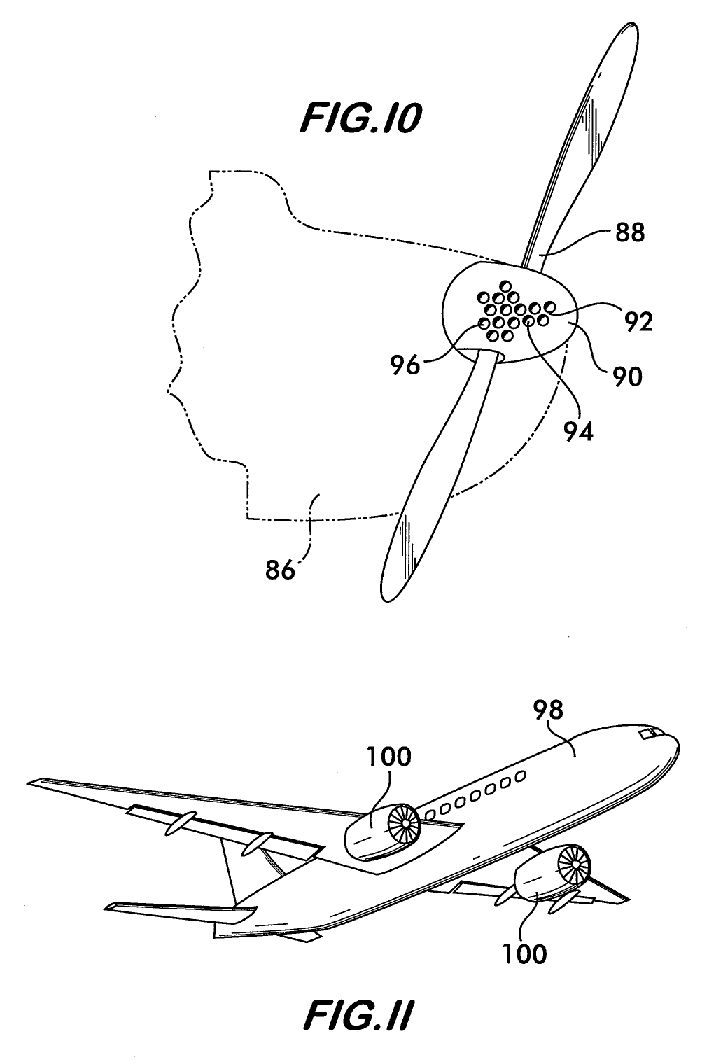

FIG. 10 illustrates another application of the shroud according to the invention used on an airplane 86, partially shown in phantom line. Airplane 86 has an aircraft propeller assembly 88 wherein a shroud 90 is attached to the propeller hub. The shroud 90 has a textured outer surface 92, which may comprise dimples 94 or projections 96 distributed over the surface. As with traditional aircraft spinners, the shroud 90 may be formed from a shell having a domed shape. It is believed that the shroud according to the invention will operate to reduce drag and thereby improve aircraft performance.

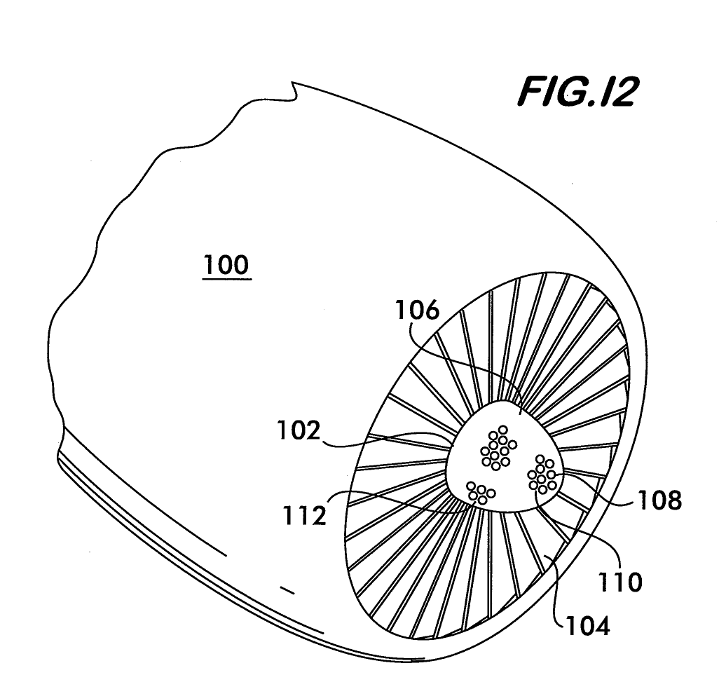

FIG. 11 shows a jetliner 98 having a turbofan engine 100. The engine, shown in detail in FIG. 12, has a fan hub assembly 102 that comprises a hub to which are attached a plurality of fan blades 104. A shroud 106 having a textured outer surface 108 is mounted on the hub. Texturing is provided by dimples 110 or projections 112 distributed over the surface of the shroud. The shroud may be formed from a shell having a domed shape. It is believed that the shroud will establish a turbulent boundary layer for air entering the engine adjacent to the shroud, and thereby reduce the transition of laminar to turbulent flow that occurs at the roots of the fan blades. The turbulent boundary layer is expected to mitigate the phenomenon of “hub choking”, and thereby enable more air to enter the engine inlet section and improve climb and cruise performance as well as help avoid compressor stall which damages jet engines.

1. A shroud positionable on a rotatable hub on which are mounted a plurality of fluid moving blades, said shroud having a textured outer surface configured so as to create a turbulent boundary layer for a fluid passing over said shroud.

2. A shroud according to claim 1, wherein said textured outer surface comprises a plurality of dimples in said outer surface.

3. A shroud according to claim 2, wherein said dimples have a round shape.

4. A shroud according to claim 1, wherein said textured outer surface comprises a plurality of projections extending from said outer surface.

5. A shroud according to claim 1, comprising a shell having a domed shape.

6. A shroud according to claim 4, further comprising a skirt attached to said shell, said skirt being positionable surrounding said hub.

7. A shroud according to claim 6, wherein said skirt is formed of a plurality of panels.

8. A helicopter rotor assembly comprising a rotatable hub to which are attached a plurality of rotor blades, and a shroud mounted on said hub, said shroud comprising a shell having a textured outer surface configured so as to create a turbulent boundary layer for air passing over said shell.

9. A helicopter rotor assembly according to claim 8, wherein said textured outer surface comprises a plurality of dimples in said outer surface.

10. A helicopter rotor assembly according to claim 9, wherein said dimples have a round shape.

11. A helicopter rotor assembly according to claim 8, wherein said textured outer surface comprises a plurality of projections extending from said outer surface.

12. A helicopter rotor assembly according to claim 8, wherein said shell has a domed shape and is mounted on top of said hub.

13. A helicopter rotor assembly according to claim 12, further comprising a skirt attached to said shell, said skirt surrounding said hub.

14. A helicopter rotor assembly according to claim 13, wherein said skirt has a textured outer surface, said outer surface of said skirt being configured so as to create a turbulent boundary layer for air passing over said skirt.

15. A helicopter rotor assembly according to claim 14, wherein said textured outer surface of said skirt comprises a plurality of dimples in said outer surface of said skirt.

16. A helicopter rotor assembly according to claim 14, wherein said textured outer surface of said skirt comprises a plurality of projections extending from said outer surface of said skirt.

17. A helicopter rotor assembly according to claim 13, wherein said skirt is formed of a plurality of panels.

18. A helicopter rotor assembly according to claim 8, wherein said hub comprises a main hub to which main rotors are attached.

19. A helicopter rotor assembly according to claim 8, wherein said hub comprises a tail hub to which tail rotors are attached.

20. A helicopter having a rotor assembly according to claim 8.

21-37. (canceled)
